(19) United States
(12) Patent Application Publication
(10) Pub. No.: US 2004/0032820 A1
(43) Pub. Date: Feb. 19, 2004

(54) Cam holder for supporting guide shaft of optical disc player

(75) Inventor: Jin-keun Choi, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co. Ltd., Suwon City (KR)

(21) Appl. No.: 10/421,872

(22) Filed: Apr. 24, 2003

(30) Foreign Application Priority Data
Aug. 13, 2002 (KR) 2002-47894

(51) Int. Cl. G11B 17/00; G11B 21/16

(52) U.S. Cl. 369/249

(57) ABSTRACT

A cam holder for supporting an end of a guide shaft for an optical pickup of an optical disk player with a cam groove used to adjust a tilt of the guide shaft. The cam holder includes an upper cam element, which is mounted on a main base, is capable of rotating, and forms a top surface of the cam groove along its circumference; and a lower cam element, which is coupled to the upper cam element, and forms a bottom surface of the cam groove along its circumference so that the top surface opposes the bottom surface of the cam groove. A hook is formed at an upper part of the lower cam element, and a step is formed at a lower part of the upper cam element so that the hook engages the step when coupling the lower cam element to the upper cam element.

### CROSS REFERENCE TO RELATED APPLICATIONS

This application claims the priority of Korean Patent Application No. 2002-47894, filed Aug. 13, 2002, in the Korean Intellectual Property Office, the disclosure of which is incorporated herein in its entirety by reference.

### BACKGROUND OF THE INVENTION

1. Field of the Invention

The present invention relates to an optical disk player, and more particularly, to a cam holder having a cam groove formed at its circumference so that an end of a guide shaft to guide reciprocation of an optical pickup, is supported by the cam groove.

2. Description of the Related Art

FIG. 1 is a plan view of a main base of a conventional optical disk player, and FIG. 2 is a bottom perspective view of the main base, on which a conventional cam holder is mounted.

In general, an optical disk player is a device for recording data on a recording medium, such as a compact disk (CD) or a digital video disk (DVD), or reproducing data stored in the recording medium by irradiating light beams on the recording medium. Referring to FIGS. 1 and 2, an optical disk player includes a spindle motor 20 for rotating a disk D and an optical pickup 30 for recording/reproducing data on/from the disk D by irradiating light beams on a recordable surface of the disk D. The spindle motor 20 and the optical pickup 30 are mounted on a main base 10 of the optical disk player, and a middle aperture 12 is formed in the main base 10 so that the optical pickup 30 can move in the middle aperture 12.

The optical pickup 30 irradiates light beams on the recordable surface of the disk D while moving along a direction of the radius of the disk D. To move the optical pickup 30, an optical pickup transferring device 40 is provided on the main base 10. The optical pickup transferring device 40 includes a screw driving motor 42, that rotates a lead screw 44, that in turn, moves the optical pickup 30. There are two guide shafts 51 and 52 provided at either side of the optical pickup 30 for guiding reciprocation of the optical pickup 30.

A tilt of the optical pickup 30 is adjustable, so that light beams emitted from the optical pickup 30 can be perpendicularly incident on the recordable surface of the disk D. In particular, the tilt of the optical pickup 30, which is coupled to the guide shafts 51 and 52, can be adjusted by adjusting a tilt of each of the guide shafts 51 and 52.

An end of each of the two shafts 51 and 52 is inserted into and supported by cam grooves 62 and 72, of cam holders 60 and 70, respectively. The cam holders 60 and 70 rotate, and are provided on the main base 10. The other end of each of the two shafts 51 and 62 are inserted into and supported by supporting elements 68 and 78, respectively, formed on the main base 10. The cam grooves 62 and 72 have a predetermined trajectory to change the elevation of each of the two shafts 51 and 52 in relation to predetermined baseline positions. Accordingly, when the cam holders 60 and 70 rotate, the elevation of the corresponding end of each of the two shafts 51 and 52 is changed by sliding along the cam grooves 62 and 72, respectively.

The cam holders 60 and 70 can be rotated manually, or automatically using a driving motor 80. For example, as shown in FIGS. 1 and 2, the cam holder 70 can be rotated manually, and the other cam holder 60 can be rotated automatically using the driving motor 80. The driving motor 80 has a driving gear 82 mounted on the main base 10, and a cam gear 84 is provided over the cam holder 60 to meet the driving gear 82.

Referring to FIG. 3, the cam holder 70 includes an upper cam element 74 rotatably mounted on the main base 10, and a lower cam element 76 coupled to the upper cam element 74 by a screw 78. A top surface 72a of the cam groove 72 is formed at a lower part of the upper cam element 74, and a bottom surface 72b of the cam groove 72 is formed at an upper part of the lower cam element 76. Accordingly, when assembling the upper cam element 74 with the lower cam element 76, the cam groove 72 is formed at the circumference of the coupled body of the upper and lower cam elements 74 and 76.

In the related art, there are multiple elements required to manufacture the cam holder 70, and the upper cam element 74 must be screwed to the lower cam element 76 using the screw 78. Therefore, it is desirable to reduce the manufacturing costs and shorten the time necessary to assemble the cam holder by reducing the number of elements.

### SUMMARY OF THE INVENTION

The present invention provides a cam holder for supporting a guide shaft of an optical disk player, that, compared to a conventional cam holder, has a reduced number of elements, and is more easily assembled.

According to an aspect of the present invention, there is provided a cam holder for supporting a guide shaft of an optical disk player. The cam holder supports an end of the guide shaft that guides reciprocation of an optical pickup, and has a cam groove at its circumference used to adjust a tilt of the guide shaft. The cam holder includes an upper cam element, that is rotatably mounted on a main base and forms a top surface of the cam groove along its circumference, and a lower cam element, that is coupled to the upper cam element and forms a bottom surface of the cam groove along its circumference, so that the top surface and bottom surface of the cam groove face each other. At least one hook is formed at an upper part of the lower cam element, and at least one step is formed at a lower part of the upper cam element so that the hook engages the step when coupling the lower cam element to the upper cam element.

According to another aspect, the step is formed at a first sidewall of a ring-shaped groove, which is formed at a lower part of the upper cam element, so that an upper part of the lower cam element can be inserted thereinto.

According to yet another aspect, the hook is formed to be thinner than the upper part of the lower cam element, and is separated from a second sidewall of the ring-shaped groove by a predetermined distance.

According to still yet another aspect, a plurality of hooks and a plurality of steps are formed along the circumference of the upper part of the lower cam element and the circumference of the lower part of the upper cam element, respectively.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a plan view of a conventional optical disk player;

FIG. 2 is a bottom perspective view of a main base, on which a conventional cam holder of FIG. 1 is mounted;

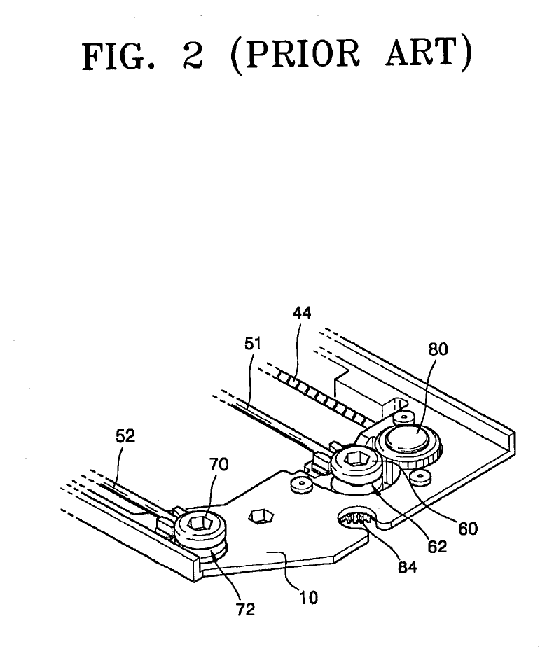

FIG. 3 is an exploded perspective view of the conventional cam holder of FIG. 1;

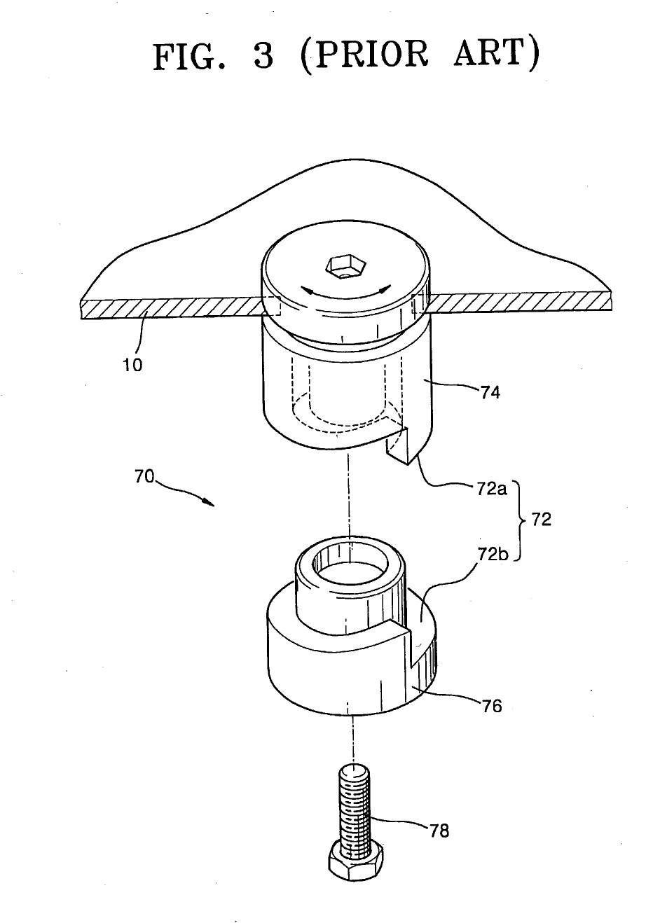

FIG. 4 is an exploded perspective view of a cam holder for supporting a guide shaft of an optical disk player according to an embodiment of the present invention;

FIG. 5 is a perspective view of the cam holder of FIG. 4; and

FIG. 6 is a vertical cross-sectional view of the cam holder of FIG. 4.

### DETAILED DESCRIPTION

Reference will now made in detail to the preferred embodiments of the present invention, examples of which are illustrated in the accompanying drawings, wherein like reference numerals refer to the like elements throughout. The embodiments are described below in order to explain the present invention by referring to the figures.

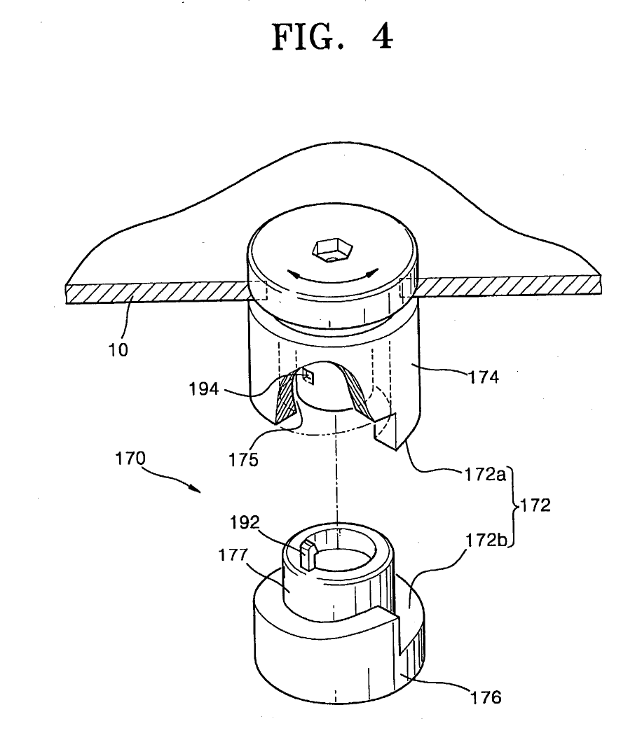

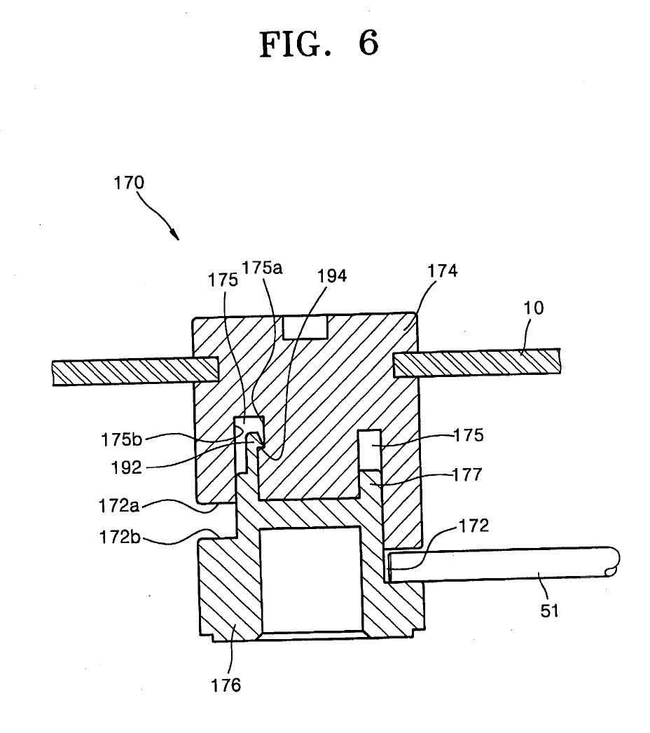

Referring to FIGS. 4 through 6, a cam holder 170 embodiment of the present invention] supports an end of a guide shaft 51, which is rotatably mounted on a main base 10 and guides reciprocation of an optical pickup. A cam groove 172 having a predetermined trajectory is formed at the circumference of the cam holder 170 so that the corresponding end of the guide shaft 51 can slide thereinto, and a tilt of the guide shaft 51 can be adjusted. Accordingly, when the cam holder 170 rotates, the corresponding end of the guide shaft 51 travels in the cam groove 172 so that the tilt of the guide shaft 51 can be adjusted.

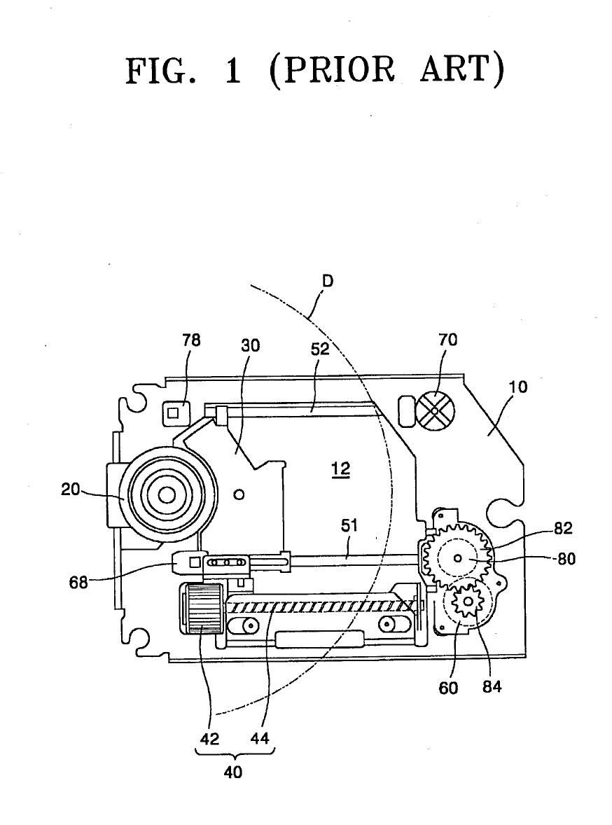

The cam holder 170 can be rotated manually, or automatically using the driving motor 80 shown in FIG. 1. In the case of an automatically rotating the cam holder 170, the cam gear 84 shown in FIG. 1 is provided over the cam holder 170 to meet the driving gear 82 shown in FIG. 1.

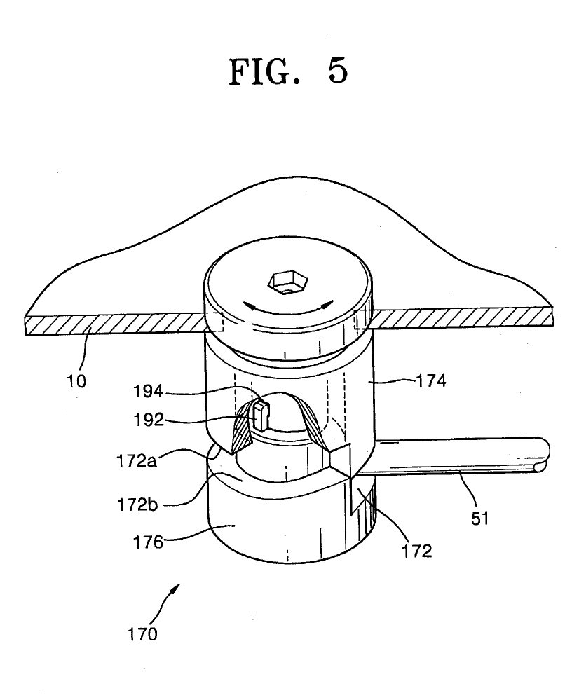

The cam holder 170 includes an upper cam element 174 mounted on the main base 10 and capable of rotating, and a lower cam element 176 coupled to the upper cam element 174. A top surface 172a of the cam groove 172 is formed at the circumference of the upper cam element 174, and a bottom surface 172b of the cam groove 172 is formed at the circumference of the lower cam element 176 so that the bottom surface 172b faces the top surface 172a. Accordingly, when coupling the upper cam element 174 and the lower cam element 176 together, the cam groove 172 is formed at the circumference of the coupled body of the upper and lower cam elements 174 and 176 to have a predetermined width and a predetermined length, as shown in FIG. 5.

The structure of the coupled body of the upper cam element 174 and the lower cam element 176 is as follows. A ring-shaped groove 175 is formed at a lower part of the upper cam element 174, and an upper end 177 of the lower cam element is inserted into the ring-shaped groove 175.

At least one hook 192 is formed at the upper end 177 of the lower cam element 176, and at least one step 194 is formed at the inner sidewall 175a of the ring-shaped groove 175. When the upper cam element 174 and the lower cam element 176 are coupled together, in other words, when the upper end 177 of the lower cam element 176 is inserted into the ring-shaped groove 175 of the upper cam element 174, the hook 192 engages the step 194.

In one aspect, the hook 192 is formed thinner than the upper end 177 to have a space provided between the hook 192 and an outer sidewall 175b of the ring-shaped groove 175. Accordingly, the hook 192 elastically moves in the space between the hook 192 and the outer sidewall 175b of the ring-shaped groove 175, and thus the upper end 177 of the lower cam element 176 can be inserted into the ring-shaped groove 175 and positively engage the upper cam element 174. According to one aspect, the cam holder 170 is formed of a plastic.

Therefore, according to the present invention, it is possible to couple the upper and lower cam elements 174 and 176 together without using screws.

Though FIG. 4 shows only one hook 192 and one step 194, the present invention should not be construed as being limited to the embodiment set forth herein. In other embodiments of the present invention, a plurality of hooks and steps may be provided along the circumference of the upper end 177 and the inner sidewall 175a of the ring-shaped groove 175. For example, two hooks and two steps for the hooks may be provided so that the two hooks form an angle of 180 degrees with each other and the two steps also form an angle of 180 degrees with each other. Alternatively, three hooks and three steps for the three hooks may be provided so that the three hooks form an angle of 120 degrees with one another and the three steps also form an angle of 120 degrees with one another. Similarly, the hooks and corresponding steps may be provided at irregular intervals along the circumference of the upper end 177 and the inner sidewall 175a, respectively.

In addition, the step 194 is shown in FIG. 4 as being recessed in the inner sidewall 175a of the ring-shaped groove 175 to a predetermined depth. The step 194, however, may also be formed at the outer sidewall 175b of the ring-shaped groove 175, which is not shown in the accompanying drawings. In this case, the hook 192 must be formed to face toward the outer sidewall 175b of the ring-shaped groove 175, and a predetermined space must be provided between the hook 192 and the inner sidewall 175a of the ring-shaped groove 175.

Since, in the present invention, screws are unnecessary in assembling the cam holder, the number of elements of the cam holder and the associated manufacturing costs may decrease. In addition, because the coupling of an upper cam element and a lower cam element may be accomplished without an additional screwing process, the time taken to assemble a cam holder may decrease.

While embodiments of the present invention have been shown and described, it will be understood by those of ordinary skill in the art that various changes in form and details may be made therein without departing from the spirit and scope of the present invention as defined by the following claims and their equivalents.

What is claimed is:

1. A cam holder, for supporting a guide shaft that guides reciprocation of an optical pickup of an optical disk player, the cam holder supporting an end of the guide shaft and having a cam groove at a circumference of the cam holder used to adjust a tilt of the guide shaft, the cam holder comprising:
a first cam element rotatably mounted on a main base with a first surface of the cam groove along a circumference of the first cam element; and
a second cam element coupled to the first cam element, with a second surface of the cam groove along a circumference, of the second cam element, so that the first surface of the cam groove opposes the second surface of the cam groove,
wherein one of a hook and a step is located on the second cam element, and the other of the hook and the step is located on the first cam element so that the hook engages the step when coupling the second cam element to the first cam element.

2. The cam holder of claim 1, wherein:
the step is located at a first wall of a groove, and the groove is located at a first part of the first cam element so that a first part of the second cam element is inserted thereinto.

3. The cam holder of claim 2, wherein:
the groove is ring-shaped.

4. The cam holder of claim 2, wherein:
the hook is thinner than the first part of the second cam element and is separated by a predetermined distance from a second wall of the groove.

5. The cam holder of claim 4, wherein:
the step is recessed in the first sidewall.

6. The cam holder of claim 4, wherein:
the first sidewall is an inner sidewall and the second sidewall is an outer sidewall.

7. The cam holder of claim 4, wherein:
the first sidewall is an outer sidewall and the second sidewall is an inner sidewall.

8. The cam holder of claim 1, further comprising:
one of a plurality of hooks and a plurality of steps located on the first part of the second cam element, along the circumference of the second cam element, and the other of the plurality of hooks and the plurality of steps are located on the first part of the first cam element, along the circumference of the first cam element.

9. The cam holder of claim 8, wherein:
the plurality of hooks and the plurality of steps are located at regular intervals.

10. The cam holder of claim 8, wherein:
the plurality of hooks and the plurality of steps are located at irregular intervals.

11. The cam holder of claim 1, wherein:
the hook moves elastically.

12. The cam holder of claim 1, wherein:
the cam holder is made of plastic.

13. The cam holder of claim 1, wherein:
the cam holder is rotated automatically.

14. The cam holder of claim 13, wherein:
the cam holder is rotated by a driving motor.

15. A cam holder to support a guide shaft of an optical disk player comprising:
a first cam element, rotatably mounted on a base, with
a first recess, located along a circumference of the first cam element at a first end of the first cam element, and
one of a hook and a step, located at the first end of the first cam element; and
a second cam element with
a second recess, located along a circumference of the second cam element at a first end of the second cam element, and
the other of the hook and the step, located at the second end of the second cam element, wherein
the hook is inserted into the step to couple the first and second cam elements, and the first and second recesses form a cam groove when the first and second cam elements are coupled.
